(19) United States
(12) Patent Application Publication
(10) Pub. No.: US 2015/0024213 A1
(43) Pub. Date: Jan. 22, 2015

(54) LIQUID COATING COMPOSITION AND A COATING METHOD USING THE SAME

(71) Applicant: FIH (Hong Kong) Limited, Kowloon (HK)

(72) Inventors: CHWAN-HWA CHIANG, New Taipei (TW); CHIEH-HSIANG WANG, New Taipei (TW)

(21) Appl. No.: 14/328,896

(22) Filed: Jul. 11, 2014

(30) Foreign Application Priority Data
Jul. 17, 2013 (CN) 2013103001533

(51) Int. Cl. C09D 133/02; B05D 3/06; C09D 163/00

(52) U.S. Cl. CPC C09D 133/02; C09D 163/00; B05D 3/067
USPC 428/413; 522/170; 522/33; 522/79; 427/508

(57) ABSTRACT

A liquid coating composition to protect electronic elements on a circuit board includes a heat curable resin composition, a photocurable resin, a photoinitiator, a curing agent, and a solvent. The heat curable resin composition includes poly(acrylic acid) oligomer and at least one compound selected from the group consisting of an epoxy resin and polyester polyol. The curing agent includes at least one compound selected from the group consisting of dicarboxylic anhydride and isocyanate. A method for applying and solidifying the liquid coating composition to form a cured film on a substrate and a resulting composite structure are also provided.

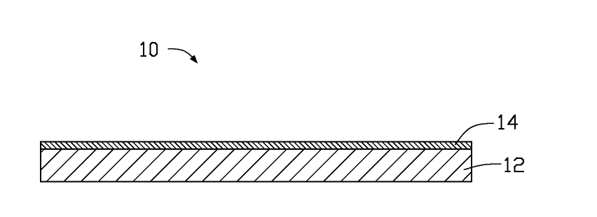

### FIELD

The present disclosure relates to a liquid coating composition and a coating method.

### BACKGROUND

Electronic devices are used in many environments and need protection in several of them.

### BRIEF DESCRIPTION OF THE DRAWING

Implementations of the present technology will now be described, by way of example only, with reference to the attached FIGURE, wherein:

The FIGURE is a cross-sectional view of a composite structure having a cured product of a coating composition according to an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series and the like.

A liquid coating composition according to an exemplary embodiment of the disclosure includes a heat curable resin composition, a photocurable resin, a photoinitiator, a curing agent, and a solvent.

Within the liquid coating composition, the heat curable resin composition has a weight percentage of about 20% to about 25%, the photocurable resin has a weight percentage of about 25% to about 35%, the curing agent has a weight percentage of about 2% to about 4%, the photoinitiator has a weight percentage of about 1% to about 4%, and the solvent has a weight percentage of about 25% to about 35%. The liquid coating composition has a saturated vapour pressure of about 5 mmHg to about 7 mmHg at room temperature.

The heat curable resin composition includes a poly(acrylic acid) oligomer and at least one compound selected from the group consisting of EPDXYLITE® and polyester polyol.

In one embodiment, the heat curable resin composition consists of poly(acrylic acid) oligomer and epoxylite, and within the heat curable resin composition the poly(acrylic acid) oligomer has a weight percentage of about 50% to about 55%, and the EPDXYLITE® has a weight percentage of about 45% to about 55%.

In another embodiment, the heat curable resin composition consists of poly(acrylic acid) oligomer and polyester polyol, and within the heat curable resin composition the poly(acrylic acid) oligomer has a weight percentage of about 25% to about 35%, and the polyester polyol has a weight percentage of about 65% to about 75%. When the liquid coating composition is cured and forms a film, the heat curable resin composition improves a hydrophobic nature and an abrasion resistance.

The poly(acrylic acid) oligomer can be selected from a group consisting of polyester acrylate (PESA), urethane acrylate (UA), acrylic resin, amine acrylate (AA), and silicon acrylate (AS).

EPDXYLITE® is a trade name for epoxy resin compositions sold by Elantas PDG, Inc. EPDXYLITE® compositions suitable for the present disclosure have at least one epoxy group. Examples of the EPDXYLITE® include but are not limited to 1,6-bis(2,3-epoxypropoxy)hexane, 1,2-cyclohexanedicarboxylic acid, 1,2-bis(2-oxiranylmethyl) ester, and 1,2-benzenedicarboxylic acid, 1,2-bis(2-oxiranylmethyl) ester.

The polyester polyol can be a copolymer of dihydric alcohol and dibasic acid or a copolymer of dihydric alcohol and tribasic acid. The polyester polyol may have a relative molecular weight in a range from about 1000 to about 5000.

The photocurable resin can be an acrylic monomer. Examples of the acrylic monomer include but are not limited to trimethtylol propane triacrylate (TMPTA), tripropylene glycol diacrylate (TPGDA), dipropylene glycol diacrylate (DPGDA), 1,6-hexanediol diacrylate (HDDA), and dipentaerythritol hexa(meth)acrylate (DPHA).

The curing agent includes at least one compound selected from the group consisting of dicarboxylic anhydride and isocyanate. If the heat curable resin composition includes the EPDXYLITE®, the curing agent includes at least the dicarboxylic anhydride of the group consisting of dicarboxylic anhydride and isocyanate, and if the heat curable resin composition comprises the polyester polyol, the curing agent includes at least the isocyanate of the group consisting of dicarboxylic anhydride and isocyanate.

The dicarboxylic anhydride is able to cross-link with the EPDXYLITE®. In detail, the dicarboxylic anhydride is able to be hydrolyzed to create carboxyl groups (—COOH) which enable ring opening reactions of the EPDXYLITE®, thereby enabling the dicarboxylic anhydride to be cross linked with the EPDXYLITE®. The EPDXYLITE® which is cross-linked with the dicarboxylic anhydride is able to undergo a polymerization reaction with the poly(acrylic acid) oligomer through interaction between the cross-linked EPDXYLITE® and hydroxyl groups on the poly(acrylic acid) oligomer.

The isocyanate is able to react with the polyester polyol to be cured under the action of heat or at room temperature. In detail, the isocyanate has two or more isocyanate functional groups (—N=C═O). The isocyanate groups are able to undergo an addition reaction with hydroxyl groups on the polyester polyol as well as amino groups (—NH2) or hydroxyl groups on the poly(acrylic acid) oligomer, thereby creating a compound RNH—CO—NHR′ or RNH—COOR′, wherein R represents the polyester polyol, and R′ represents the poly(acrylic acid) oligomer.

The photoinitiator can be phenyl ketone, such as 1-hydroxycyclohexyl phenyl ketone, 2-hydroxy-Methyl phenyl propane-1-ketone, 1,2-benzil, benzophenone, benzoin, and derivatives of benzoin ether. The photoinitiator can produce free radicals under UV-light irradiation. The produced free radicals can initiate a free-radical polymerization between the poly(acrylic acid) oligomer and double bonds on the photocurable resin.

The solvent can be an organic solvent, such as ethyl acetate, butyl acetate, or xylene.

The liquid coating composition can be prepared by stirring a mixture of the heat curable resin composition, the photocurable resin, the photoinitiator, the curing agent, and the solvent at a stir rate of about 200 revolutions per minute (rpm) to about 400 rpm, for about 20 minutes to about 40 minutes.

A exemplary coating method using the liquid coating composition to form a waterproof film on a substrate may include the following steps.

The substrate is provided. The substrate can be any material to be protected from water penetration, such as a circuit board or mainboard of an electronic device.

The liquid coating composition is coated onto an entire surface of the substrate to form a liquid film such as spray and dip coating. To prevent air bubbles between the surface of the substrate and the film, the film can be formed under vacuum conditions, such as under an atmosphere pressure of about −5 Pa to about 5 Pa.

The substrate having the film applied undergoes a first curing process by exposure to UV-light. During the first curing process, the photoinitiator absorbs the UV-light and produces free radicals. The produced free radicals initiate a free-radical polymerization between the poly(acrylic acid) oligomer and double bonds on the photocurable resin. By the first curing process, areas of the film exposed to UV-light can be cured to solid form. Some areas, such as areas located in notches and/or small openings in the surface which cannot be exposed to UV-light, may remain liquid.

A second curing process is implemented to cure the remaining liquid areas of the film. The second curing process can be carried out at room temperature. During the second curing process, the substrate with the film can be retained at room temperature for about 6-8 days. The dicarboxylic anhydride in the film is hydrolyzed by water initiated hydrolysis under atmospheric conditions, to create carboxyl groups which enable ring opening reactions of the EPDXYLITE®, thereby enabling the dicarboxylic anhydride to be cross linked with the EPDXYLITE®. The EPDXYLITE® which is cross-linked with the dicarboxylic anhydride undergoes a polymerization reaction with the poly(acrylic acid) oligomer through interaction between the cross-linked EPDXYLITE® and hydroxyl groups on the poly(acrylic acid) oligomer. The isocyanate groups on the isocyanate undergo an addition reaction with hydroxyl groups on the polyester polyol as well as amino groups or hydroxyl groups on the poly(acrylic acid) oligomer, thereby creating the compound RNH—CO—NHR′ or RNH—COOR′. Thus the wet areas of the film not exposed to UV-light are cured to solid form.

To shorten a period of the second curing process, the substrate with the film can be heated. For example, a temperature of about 50° C. to about 70° C. for about 24 hours to about 36 hours can be applied to the substrate with the film, to cure the liquid areas of the film.

The FIGURE shows an embodiment of a composite structure 10 created by the above method. The composite structure 10 includes a substrate 12, and a cured film 14 of a liquid coating composition of the present disclosure as described above, formed on the substrate 12. The substrate 12 can be a circuit board or a mainboard of an electronic device.

### Tests and Results

Mainboards of calculators with surfaces entirely coated with the cured film of a liquid coating composition of the present disclosure, as described above, were immersed in water. The results show that the calculators resisted the water for about 20 minutes to about 40 minutes before short-circuiting.

The embodiments shown and described above are only examples. Many details are often found in the art such as the other features of a server. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A liquid coating composition, comprising:
a heat curable resin composition comprising poly (acrylic acid) oligomer and at least one compound selected from the group consisting of an epoxy resin and polyester polyol;
a photocurable resin;
a photoinitiator;
a curing agent comprising at least one compound selected from the group consisting of dicarboxylic anhydride and isocyanate; and
a solvent.

2. The liquid coating composition of claim 1, wherein if the heat curable resin composition includes the epoxy resin, the curing agent includes at least the dicarboxylic anhydride of the group consisting of dicarboxylic anhydride and isocyanate, and if the heat curable resin composition comprises the polyester polyol, the curing agent includes at least the isocyanate of the group consisting of dicarboxylic anhydride and isocyanate.

3. The liquid coating composition of claim 1, wherein the photocurable resin is acrylic monomer.

4. The liquid coating composition of claim 3, wherein the acrylic monomer is selected from the group consisting of trimethtylol propane triacrylate, tripropylene glycol diacrylate, dipropylene glycol diacrylate, 1,6-hexanediol diacrylate, and dipentaerythritol hexa(meth)acrylate.

5. The liquid coating composition of claim 1, wherein the poly(acrylic acid) oligomer is selected from the group consisting of polyester acrylate, urethane acrylate, acrylic resin, amine acrylate, and silicon acrylate.

6. The liquid coating composition of claim 1, wherein the epoxy resin is selected from the group consisting of 1,6-bis(2,3-epoxypropoxy)hexane, 1,2-cyclohexanedicarboxylic acid, 1,2-bis(2-oxiranylmethyl) ester, and 1,2-benzenedicarboxylic acid, 1,2-bis(2-oxiranylmethyl) ester.

7. The liquid coating composition of claim 1, wherein the photoinitiator is phenyl ketone.

8. The liquid coating composition of claim 7, wherein the phenyl ketone is selected from the group consisting of 1-hydroxycyclohexyl phenyl ketone, 2-hydroxy-methyl phenyl propane-1-ketone, 1,2-benzil, benzophenone, benzoin, and of benzoin ether derivatives.

9. The liquid coating composition of claim 1, wherein the solvent is selected from the group consisting of ethyl acetate, butyl acetate, and xylene.

10. The liquid coating composition of claim 1, wherein the polyester polyol can be a copolymer of dihydric alcohol and dibasic acid or a copolymer of dihydric alcohol and tribasic acid; the polyester polyol has a molecular weight in a range from about 1000 to about 5000.

11. A method for using the liquid coating composition according to claim 1 to form a cured film on a substrate, the method comprising:
providing a substrate;
coating the liquid coating composition to from a film initially in a liquid form;
exposing the substrate having the film to UV-light, thereby curing areas of the film exposed to UV-light; and
retaining the substrate having the film under the room temperature or under a temperature of about 50° C. to about 70° C. to cure areas of the film not exposed to UV-light.

12. A composite structure comprising a substrate, and a cured film of a liquid coating composition according to claim 1, formed on the substrate.

13. The composite structure of claim 12, wherein the substrate is a circuit board.

14. The composite structure of claim 12, wherein the substrate is a mainboard.
